(19) United States
(12) Patent Application Publication
(10) Pub. No.: US 2010/0217899 A1
(43) Pub. Date: Aug. 26, 2010

(54) MUNITIONS CONTROL UNIT

(75) Inventors: Richard L. Sitzmann, Tucson, AZ (US); Ryan J. Peters, Tucson, AZ (US); Alan Haggh, Tucson, AZ (US)

Correspondence Address: MARK D. SARALINO (GENERAL);RENNER, OTTO, BOISSELLE & SKLAR, LLP, 1621 EUCLID AVENUE, NINETEENTH FLOOR, CLEVELAND, OH, 44115-2191, US

(73) Assignee: RAYTHEON COMPANY, Waltham, MA (US)

(21) Appl. No.: 11/694,000

(22) Filed: Mar. 30, 2007

Related U.S. Application Data
(60) Provisional application No. 60/887,433, filed on Jan. 31, 2007.

(51) Int. Cl. G06F 13/12; G06F 13/20; G09G 5/00

(52) U.S. Cl. 710/69; 710/313; 345/619

(57) ABSTRACT

A munitions control unit for integrating existing vehicle electronics with at least one weapon, wherein said existing vehicle electronics are not equipped to interface with the at least one weapon includes a first I/O interface for communicating control signals with said vehicle, at least one second I/O interface different from the first I/O interface, said at least one second I/O interface communicating control signals with said weapon, a processor and memory operatively coupled to said first and at least one second I/O interface, and reconfigurable logic stored in memory and executable by the processor. The reconfigurable logic is operative to enable the munitions control unit to interface with a plurality of vehicles having different interfaces.

### RELATED APPLICATION DATA

This application claims priority of U.S. Provisional Application No. 60/887,433 filed on Jan. 31, 2007, which is incorporated herein by reference in its entirety.

### FIELD OF THE INVENTION

The present invention relates generally to vehicles and vehicle weaponry. More specifically, the invention relates to a munitions control unit and method for integrating one or more weapons on vehicles that are not otherwise equipped to handle such weaponry.

### BACKGROUND OF THE INVENTION

Until recently, an aircraft and the stores which it carried were typically developed independently of each other or were developed exclusively for each other. This practice usually resulted in unique aircraft/store electrical interconnection requirements, the general proliferation of overall store interface designs, low levels of interoperability, and costly aircraft modifications to achieve required store utilization flexibility. Trends in store technology toward more complex store functions requiring increasing amounts of avionics data and control information from aircraft systems were predicted to lead to a multitude of aircraft/store interfacing problems.

In late 2003, the U.S. Department of Defense promulgated MIL-STD-1760 revision D (hereinafter referred to MIL-STD-1760). The stated goal of MIL-STD-1760 is to develop aircraft that are compatible with a wide variety of stores and stores that are compatible with a wide variety of aircraft. MIL-STD-1760 accomplishes this goal by defining a standard electrical (and fiber optic) interconnection system for aircrafts and stores. This interconnection system is based on the use of a standard connector, a standard signal set and a standard serial digital interface for control, monitor, and release of stores.

Newly produced tactical aircraft are internally wired with the MIL-STD-1553 data bus for coupling to the MIL-STD-1760 standard weapons interface. Modern smart weapons such as the Joint Direct Attack Munition (JDAM) are designed to communicate with the aircraft via such interface to obtain control, monitor and release information from the aircraft in order to carry out mission critical operations.

Unfortunately, the overwhelming majority of legacy aircraft in use today are not properly equipped to interface with the MIL-STD-1760 interface of modern tactical weapons systems. Further, economic constraints dictate that the lives of existing aircraft must be stretched, making the incorporation of new weapons and weapon systems into existing airframes necessary.

Since many of the legacy aircraft were developed during the early to mid-1970's, before the onslaught of digital electronics, they typically are based on an analog or analog/digital hybrid system that utilize extensive wiring and unique dedicated hardware/software, most of which (if not all) is not compatible with the MIL-STD-1760 interface.

As a result, integration of new weapons systems on legacy aircraft that lack these standards can require unique hardware and/or software in the host aircraft. Such hardware and/or software can be both complex and costly to design and implement. In some cases, the costs may deter weapons upgrades on aging aircraft platforms.

### SUMMARY OF THE INVENTION

An apparatus and method in accordance with present invention enables legacy military vehicles, such as military aircraft, to be upgraded with the latest state of the art weapons without the high costs associated with dedicated hardware and software modifications and/or upgrades. The apparatus can include standardized hardware (i.e., hardware that is not specific to a certain model or family of vehicles) and provides an interface between existing electronics of the vehicle and the electronics of the weapon such that integration is seamless and straight forward. Any input (e.g., analog, discrete, serial, etc.) can be handled by the device. An existing weapon interface need not be present in the vehicle.

By utilizing various I/O (input/output) points of the apparatus and of the vehicle's electronics, existing controls can be integrated with the new weapons with little or no reconfiguration of the vehicle's electronics or of the weapon's electronics. Both analog weapons and MIL-STD-1553 compliant weapons may be controlled. Moreover, the device can be reprogrammable or reconfigurable, such that a single standard device can be used to interface with any number of different vehicle types. Further, additional weapon control capability may be added via programming.

According to one aspect of the invention, there is provided a munitions control unit for integrating existing vehicle electronics with at least one weapon, wherein said existing vehicle electronics are not equipped to interface with the at least one weapon.

The munitions control unit includes a first I/O interface operative to communicate control signals with said vehicle; at least one second I/O interface different from the first I/O interface, said at least one second I/O interface operative to communicate control signals with said weapon; a processor and memory operatively coupled to said first and at least one second I/O interface; and reconfigurable logic stored in memory and executable by the processor, said reconfigurable logic operative to exchange communication signals between the first and at least one second I/O interface.

According to another aspect of the invention, there is provided a method for integrating existing vehicle electronics with at least one weapon, wherein said existing vehicle electronics are not equipped to interface with the at least one weapon. The method includes communicatively coupling a first I/O interface of a munitions control unit to the vehicle; communicatively coupling at least one second I/O interface of the munitions control unit to the weapon, said at least one second I/O interface being different from the first I/O interface; and communicatively coupling at least one I/O point of the first I/O interface to at least one I/O point of the at least one second I/O interface, wherein communicatively coupling the respective I/O points includes storing reconfigurable logic onto the munitions control unit, said reconfigurable logic defining a communication path between the at least one I/O point of the first I/O interface and the at least one I/O point of the at least one second I/O interface.

According to another aspect of the invention, there is provided a munitions control for integrating existing vehicle electronics with at least one weapon, wherein said existing vehicle electronics is not equipped to interface with the at least one weapon. The munitions control unit includes a first I/O section operative to communicate I/O data with the vehicle; a second I/O section operative to communicate I/O data with the at least one weapon; and a reconfigurable processing section for correlating I/O points of the first I/O section with corresponding I/O points of the second I/O section.

To the accomplishment of the foregoing and the related ends, the invention, then, comprises the features hereinafter fully described in the specification and particularly pointed out in the claims, the following description and the annexed drawings setting forth in detail certain illustrative embodiments of the invention, these being indicative, however, of but several of the various ways in which the principles of the invention may be suitably employed.

Other systems, methods, features, and advantages of the invention will be or become apparent to one with skill in the art upon examination of the following drawings and detailed description. It is intended that all such additional systems, methods, features, and advantages be included within this description, be within the scope of the present invention, and be protected by the accompanying claims.

Although the invention is shown and described with respect to one or more embodiments, it is to be understood that equivalents and modifications will occur to others skilled in the art upon the reading and understanding of the specification. The present invention includes all such equivalents and modifications, and is limited only by the scope of the claims.

Also, although the various features are described and are illustrated in respective drawings/embodiments, it will be appreciated that features of a given drawing or embodiment may be used in one or more other drawings or embodiments of the invention.

### BRIEF DESCRIPTION OF THE DRAWINGS

Many aspects of the invention can be better understood with reference to the following drawings. The components in the drawings are not necessarily to scale, emphasis instead being placed upon clearly illustrating the principles of the present invention. Likewise, elements and features depicted in one drawing may be combined with elements and features depicted in additional drawings. Additionally, in the drawings, like reference numerals designate corresponding parts throughout the several views.

FIG. 1 is a schematic fragmented elevational view of an aircraft with a launcher and an associated store removably affixed to its wing.

FIG. 2 is block diagram illustrating the relationship between a munitions control unit in accordance with the invention, an aircraft and a weapon.

FIG. 3 is a block diagram of the logical architecture of a munitions control unit in accordance with one aspect of the present invention.

FIG. 4 is a schematic diagram illustrating an exemplary mapping of data from a legacy aircraft to a state of the art weapon in accordance with the invention.

FIG. 5 is block diagram illustrating a computer coupled to the munitions control unit in accordance with the invention.

FIG. 6 is a block diagram of an exemplary computer that may be used to communicate and/or control the munitions control unit in accordance with the invention.

### DESCRIPTION OF THE INVENTION

The following is a detailed description of the present invention with reference to the attached drawings, wherein like reference numerals will refer to like elements throughout.

The present invention relates to a munitions control unit for communicatively coupling a weapon to a vehicle, such as an aircraft, that is not otherwise equipped to handle such weapon. The munitions control unit can directly interface with the electronics of both the weapon and the vehicle and, as a result, the electronics of both systems need not be changed to accommodate the other. Moreover, the munitions control unit can utilize standard hardware that need not be tailored to the vehicle.

Because the invention was conceived and developed for use in military aircraft, it will be herein described chiefly in this context. However, the principles of the invention in their broader aspects can be adapted to other types of vehicles, including armored assault vehicles, or the like.

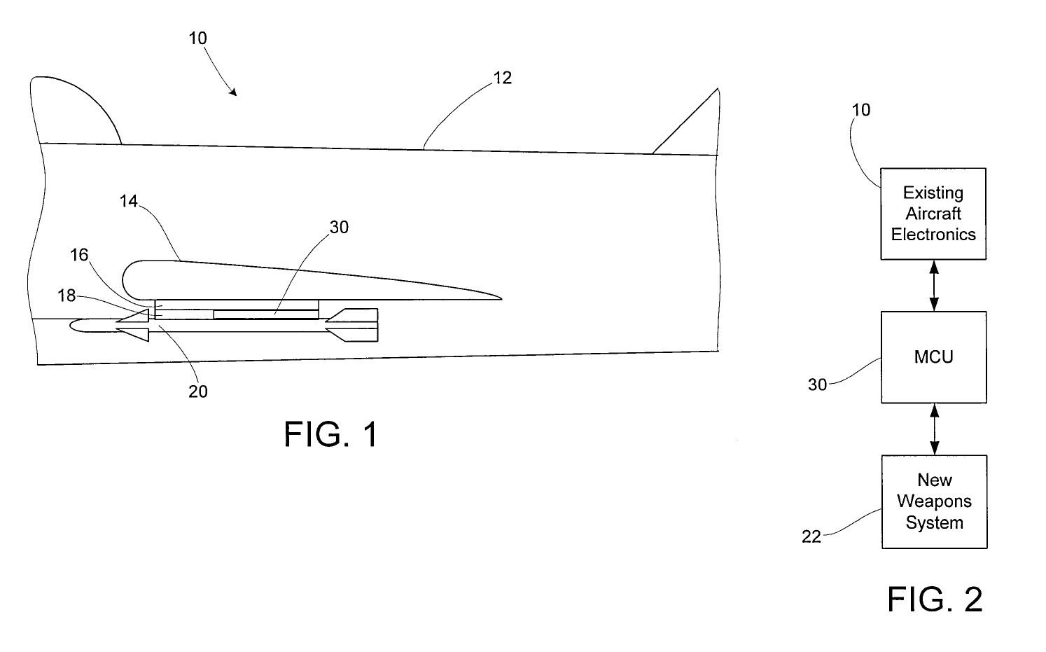

Referring to FIG. 1, a portion of an aircraft 10 having a fuselage 12 and a wing 14 extending therefrom is shown. The aircraft 10 can be any type of aircraft, including fighter jets (e.g., the A-10, F-15 and F-16) and helicopters (e.g., AH-64 and AH-1). Extending downwardly from the wing 14 is a bomb rack 16, a launcher 18 attached to the bomb rack 16, and a store 20 (also commonly referred to as a missile) supported from the launcher 18. The bomb rack 16 can be any type of bomb rack, including bomb racks capable of storing a single store or multiple stores. Likewise, while the launcher 18 has been described as being attached to the bomb rack, the launcher 18 may instead be supported from the fuselage 12 or the launcher 18 may extend from a wingtip or other location on the aircraft 10. The bomb rack 16, launcher 18 and/or store 20 may be collectively referred to as a weapon or weapon system 22.

The store 20 may be any type of store capable of being carried by an aircraft 10, including an air-to-air missile, air-to-surface missile, laser guided bomb, etc. As an example, the store 20 may be a member of the Maverick, JSOW (Joint Standoff Weapon) or Paveway family of weapons, manufactured by the assignee of the present application, Raytheon Company of Lexington, Mass.

As shown in FIG. 1, a munitions control unit (MCU) 30 interfaces with the weapon 22. The MCU 30, for example, may be removably attached to the launcher 18 or may be integral to the launcher 18. Preferably, the MCU 30 is housed within the launcher 18. However, the MCU 30 may also be housed externally to the launcher 18 (e.g., the MCU 30 may be located on or in the wing 14 or fuselage 12).

FIG. 2 is a block diagram showing an exemplary relationship between the MCU 30, the aircraft 10 and the weapon 22. In the example of FIG. 2, the aircraft 10, due to its dated technology, is not equipped to interface with the state of the art electronics of the new weapon 22. For example, the aircraft 10 may not include an MIL-STD-1553 data bus or any other type of standard data bus intended for communicating with a particular weapon. Moreover, the aircraft 10 may not have the necessary control systems to provide the MIL-STD-1760 control to the weapon 22. The MCU 30, however, which includes electronics that enable interface with legacy systems as well as state of the art systems, can interface with both the aircraft 10 and the weapon 22, as shown in FIG. 2. The MCU 30 can provide the control signals from the aircraft 10 to the weapon 22 in the proper format so as to enable weapons operation with legacy aircraft, as described in more detail below.

As will be appreciated, the types of aircraft that will benefit most from the MCU 30 do not have standardized weapons interfaces. The MCU 30 described herein can provide the necessary communications that enable the aircraft 10 to operate the weapon 22. Moreover, the MCU 30 can be a standard device that is capable of interfacing with any one of a plurality of different aircraft and weapons, without the need to specifically tailor the hardware of the MCU 30 for each aircraft and/or weapon.

In operation, the MCU 30 acts as a translator between the legacy aircraft's electronics and the weapon's electronics. More specifically, the MCU 30 accepts inputs from and provides outputs to the legacy aircraft 10 in its native format, and provides outputs to and accepts inputs from the weapon 22 in its native format. Thus, neither the legacy aircraft's electronics nor the weapon's electronics need to be modified to enable one system to work with the other.

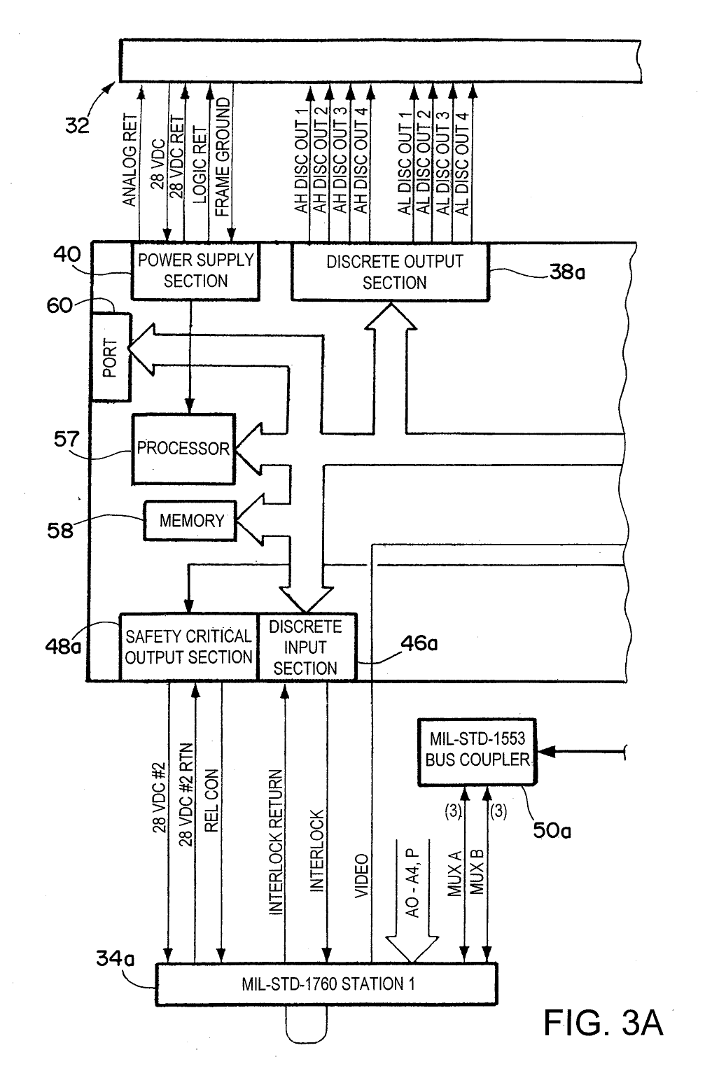

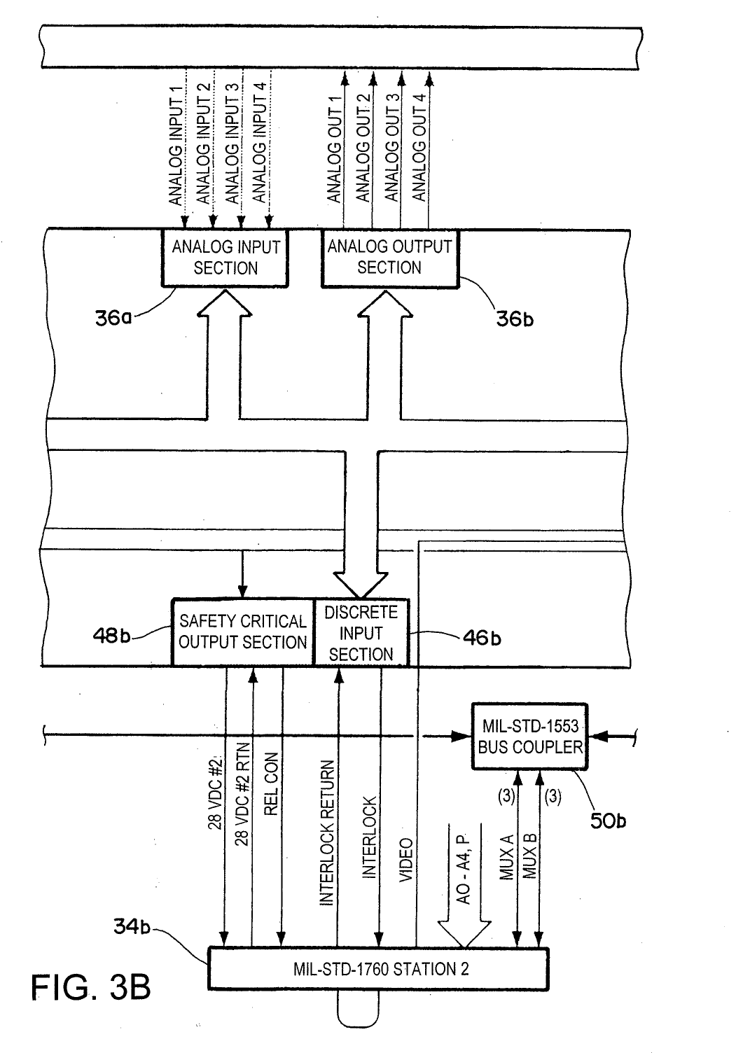

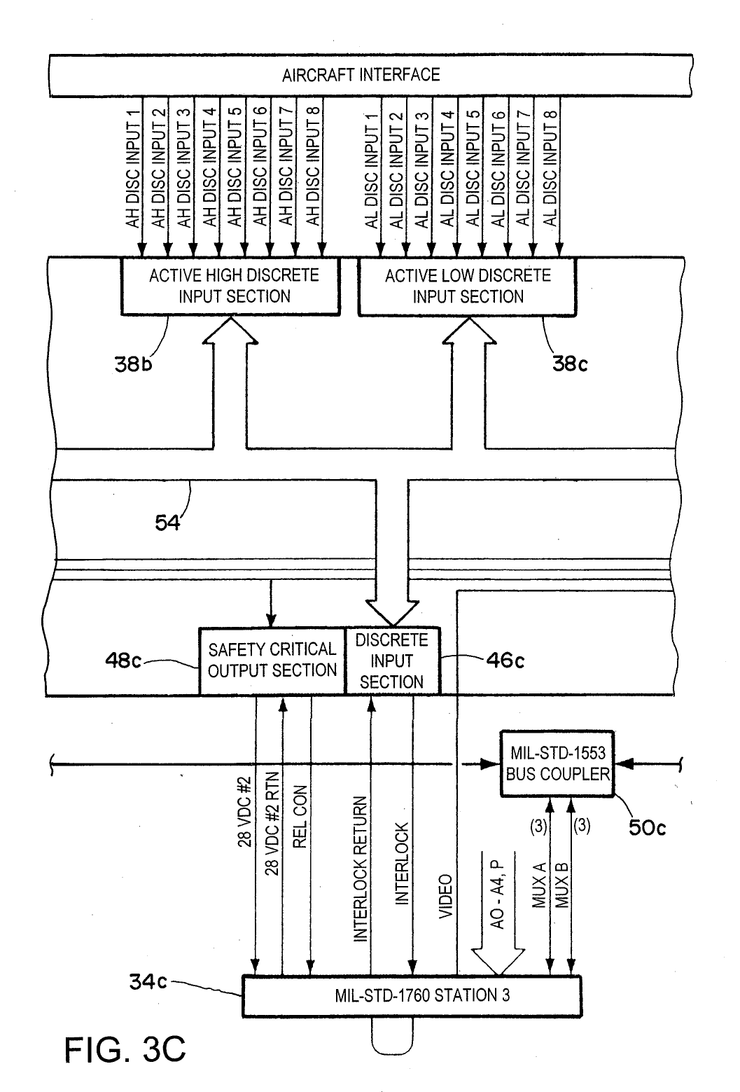

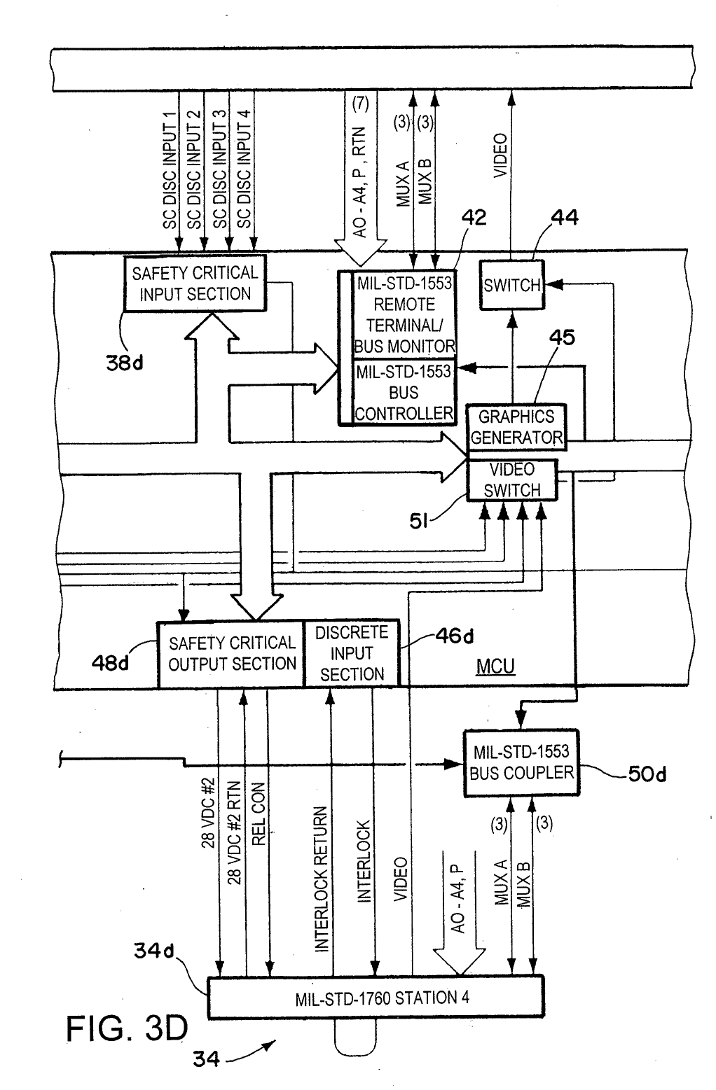

Referring to FIG. 3, a block diagram of the logical architecture of an exemplary MCU 30 in accordance with one aspect of the present invention is shown. The MCU 30 includes an aircraft interface 32 (also referred to as a legacy interface), a plurality of MIL-STD-1760 compliant interfaces 34a-34d (referred to generally as MIL 1760 interface 34), a plurality of AIMS interfaces 35 and a CART interface 37. The aircraft interface 32 may be used to interconnect the MCU 30 to the electronics of the aircraft 10, while each MIL 1760 interface 34a-34d may be used to connect to one or more weapons 22. In the exemplary MCU 30 of FIG. 3, up to four weapons 22 (e.g., four air to ground weapon stations) may be controlled, although this number can be increased or decreased by adding or removing MIL 1760 interfaces. Preferably, the MCU is compatible with MIL-STD-704A.

In addition to the MIL 1760 interfaces 34a-34d, the MCU 30 can also include one or more air-to-air weapon stations 35a-35b (referred to generally as AIMS 35). In the present example, two air-to-air stations 35a and 35b are shown, although it will be appreciated that more or fewer stations may be provided without departing from the scope of the invention. The AIMS interfaces 35 may be utilized to interface with air-to-air weapons such as the sidewinder missile, for example. As will be appreciated, any weapon system that is compliant with the AIMS protocol may be coupled to the AIMS interfaces 35.

The MCU 30 also may include a CART interface 37. The CART interface 37 enables the MCU 30 to control the release of gravity weapons without changing aircraft hardware/software. The CART interface 37 is described in more detail below.

The aircraft interface 32, the MIL 1760 interfaces 34, the AIMS interfaces 35, and the CART interface 37 may comprise a connector, terminal board, fiber optic connection, or the like that facilitates connection (electrical or fiber optic) between the MCU 30 and the aircraft 10 and between the MCU 30 and the weapon 22. Preferably, the aircraft interface 32, the MIL 1760 interfaces 34, the AIMS interfaces 35 and the CART interface 37 are mounted directly on the MCU 30, although each may be separately mounted and coupled to the MCU 30 via a cable or the like.

The aircraft interface 32 includes a plurality of analog and digital I/O points. More specifically, the aircraft interface 32 includes a plurality of analog inputs 36a and a plurality of analog outputs 36b (e.g., 0-5 volt analog inputs and outputs, or the like). Similarly, the aircraft interface 32 also includes a plurality of digital or discrete outputs 38a and discrete inputs 38b (e.g., active high), 38c (e.g., active low) and 38d (e.g., safety related inputs). These analog and digital I/O are not dedicated I/O points (i.e., they are not assigned to a specific function of the aircraft), and may be coupled to any analog or digital I/O point of the aircraft 10. The selection of the appropriate I/O points (analog 36a and 36b and/or digital 38a, 38b and 38c) can be based upon the electronics present in the host aircraft 10.

The aircraft interface 32 further includes a power supply interface 40, which may be used to provide power to the MCU 30 and to provide a return path for analog and digital I/O (i.e., a path that completes the analog or digital circuit). The power supply interface includes, for example, a frame ground input for coupling the MCU frame to aircraft ground, a logic return (e.g., digital common) for electrically completing the digital input and output circuits, an analog return for electrically completing the analog input and output circuits, and 28 VDC and 28 VDC Ret for powering the MCU 30.

Additionally, the aircraft interface 32 may include an MIL-STD-1553 bus interface and controller 42 for interfacing with a serial data bus that may be present on the aircraft 10. As is well known, the MIL-STD-1553 is a military standard that defines the mechanical, electrical and functional characteristics of a serial data bus. The bus interface and controller 42 enables the MCU 30 to serially communicate with the aircraft's existing electronics (provided the aircraft is capable of serial communications using the MIL-STD-1553 standard) as well as with the MIL 1760 interfaces 34a-34d.

The aircraft interface 32 also can include a first video switch 44 for transmitting video signals to the aircraft (e.g., an RS-170 video output to the aircraft). Such video signals may include, for example, images of a target of an adversary, or of a flight path of the weapon once it has been deployed, or any other image provided by the weapon 22. The first video switch 44 can be operatively coupled to a graphics generator 45 of the MCU 30, which can render graphical images for display in the aircraft 10. Further, audio connections 47 can provide audio signals from each AIMS interface 35a and 35b to the aircraft (e.g., one audio signal per AIMS interface).

Moving now to the MIL 1760 interfaces 34, each MIL 1760 interface 34a-34d includes discrete I/O 46a-46d, respectively, for accepting and providing various I/O points to/from the weapon 22. These I/O points may include, for example, interlocks (e.g., INTERLOCK and INTERLOCK RETURN), ready signals, etc. that may be used for operation of the weapon (e.g., to fire the weapon, monitor a target, etc.). Each MIL 1760 interface 34a-34d also includes safety critical I/O 48a-48d, respectively, for accepting and providing safety related I/O to/from the weapon 22 (e.g., I/O used to ensure safe and proper operation of the weapon 22). Such safety critical I/O may include, for example, confirmation that the weapon is operational (e.g. no faults within the weapon), release consent (REL CON), as well as safety critical power (28 VDC #2 and 28 VDC #2 RTN) to the weapon 22. Preferably, the safety critical power (28 VDC #2 and 28 VDC#2 RTN) from the MCU 30 is provided from a separate power supply than the aircraft power (28 VDC) provided via the power supply interface 40.

In addition to the safety critical power (28 VDC2), the aircraft 10, independent of the MCU 30, preferably provides 115 VAC, 400 Hz 3 phase power, and 28 VDC power to the weapon 22.

Further, each MIL 1760 interface 34a-34d can be coupled to the MIL-STD-1553 bus interface and controller 42 via a bus coupler 50a-50d, respectively. Each bus coupler 50a-50d effectively acts as a node on a network, thereby enabling each of the MIL 1760 interfaces 34a-34d to serially communicate using the MIL-STD 1553 protocol. Thus, in addition to the discrete I/O 48a-48d and 46a-46d, each MIL 1760 interface 34a-34d may directly communicate to other MIL 1760 interfaces, or indirectly communicate to the aircraft 10 (e.g., via the bus interface and controller 42 and aircraft interface 32 of the MCU 30). Also, video data (e.g., RS-170 video) can be provided from each MIL 1760 interface 34a-34d to the MCU 30 via a second video switch 51, which also is coupled to the graphics generator 45. The video data may include images obtained from the weapon 22 (e.g., a view of the target from the perspective of the weapon), which can be provided to the aircraft for display or can be recorded for later analysis.

Moving to the AIMS interfaces 35, each AIMS interface 35a and 35b includes discrete outputs 52 and discrete inputs 53 for providing and accepting various I/O points to/from the weapon 22. The discrete outputs may include, for example, commands to fire the weapon (FIRE ½), a master arm command (MSTR_ARM ½), an interlock for releasing the weapon (UNCAGE ½), a cool down command to begin seeker cool down (COOL ½). The discrete inputs may include a signal verifying the weapon is present and/or the weapon is a particular type of weapon (e.g., MSL_IDENT ½).

The AIMS interface 35 also may include other means for interfacing with the weapon 22, such as a SEAM board 55 (sidewinder expanded acquisition mode). SEAM is a method of slaving the weapon, such as a seeker of a sidewinder missile, to the aircraft radar. This enables the aircraft avionics system to slave the seeker up to a given number of degrees from the missile/aircraft bore sight axis. The missile seeker typically is slaved until an audible signal indicates seeker target acquisition. The audible signal may be communicated via the audio connections 47, which are coupled between the aircraft interface 32 and each AIMS interface 35a and 35b. Upon target acquisition, a seeker interlock in the missile is released (e.g., UNCAGE ½), and the missile seeker begins to track the target. The SEAM board 55 may exchange conventional signals with the AIMS stations 54, examples of which may include a reference signal (SEAM_REF ½), SEAM slave enable signal (SEAM_SLV ½), lock on command (SM_LKON ½) and lambda, which may be an equation for slaving the seeker to the aircraft radar (LAMBDA ½).

Moving now to the CART interface 37, the CART interface 37 is coupled to a CART reroute section 56. The CART reroute section 56 and CART interface 37 enable the MCU 30 to perform critical cart fire functions to release both smart and dumb weapons. More specifically, the CART interface 37 and CART reroute section 56 enable the MCU 30 to control the release of gravity weapons without changing aircraft hardware/software.

For example, if the aircraft 10 has a rail launched weapon (e.g., a launcher 18 embodied as a rail), such as a Maverick missile, in inventory, and the MCU 30 is attached to the weapon via one of the MIL 1760 interface 34a-34d, then actuating a weapons release will fire the rocket motor of the weapon, and the weapon will accelerate along the rail and disengage from the aircraft 10. The rail or launcher 18, however, will remain on the aircraft 10 after the weapon 22 has been fired. In other words, the weapons release will not fire the carts (e.g., the bomb rack 16) that hold the launcher 18 to the aircraft 10, since this is not part of a normal weapons release for a Maverick or similar weapon. If the carts were released, the launcher 18 (e.g., the rails and associated hardware) would be dropped from the aircraft, which is not desired since the launcher 18 can be reused. A gravity bomb, however, is released (e.g., dropped) from the aircraft, which typically is accomplished by firing the carts (e.g., the bomb rack) that hold the weapon to the aircraft.

The CART interface 37 and CART reroute section 56, based on the type of weapon, reroutes the weapon release signal to the MCU 30, which can either fire the rocket motor or fire the carts (e.g., open or disengage the bomb rack) depending on the weapon type. A typical signal output provided by CART reroute section 56 includes a command to retract or release the cart (CART_OUT). The CART reroute section 56 also is typically provided with a signal indicative of the current CART status (CART_IN) (e.g., is the cart in the in or out position).

It is noted that the I/O points described with respect to each interface are merely exemplary. Many I/O points are aircraft and/or weapon specific and, therefore, the I/O points may change based on the aircraft and weapon system connected to the MCU 30. The I/O points described above may or may not be used on every aircraft and/or weapon system.

Within the MCU 30, a bus 54 is coupled to and under the control of processor 57. Also operatively coupled to the bus 54 is the graphics generator 45, the analog I/O 36a-36b of the aircraft interface 32, the discrete I/O 38a-38D of the aircraft interface 32, the bus interface and controller 42, the discrete I/O 46a-46d and 48a-48d of the MIL 1760 interfaces 34a-34d, the discrete I/O 52 and 53 and the SEAM board 55 of the AIMS interfaces 35, and the CART reroute section 56 of the CART interface 37. The bus 54 enables data to be moved from various I/O of the aircraft interface 32, the MIL 1760 interfaces 34, graphics generator 45, bus controller 42, etc. for manipulation by the processor 57. The processor 57, in conjunction with memory 58 (e.g., read only memory, random access memory, etc.) executes code so as to move data between the aircraft interface 32, the MIL 1760 interfaces 34a-34d, the AIMS interfaces 35, and the CART interface 37. More specifically, the processor 57 can control the operation of the respective interfaces 32, 34, 35 and 37. For example, an aircraft station select function, which may be based on a requested weapon type by the pilot, may be executed by the processor 57 so as to enable and/or disable certain ones of the MIL 1760 interface 34, the AIMS interfaces 35 and/or the CART interface 37.

A communication port 60, such as a programming port or the like, is operatively coupled to the bus 54. The communication port 60 enables application specific code to be loaded into memory 58 of the MCU 30, which then may be executed by the processor 57. For example, application code that defines the configuration of the aircraft interface 32 relative to each of the MIL 1760 interfaces 34a-34d can be developed offline. Then, once complete, the application specific code can be loaded into the MCU 30 via the communication port 60. In this manner, a single, standardized MCU can accommodate any number of vehicles, each of which may have different interfaces.

Information (e.g., digital, analog and serial data) received from the aircraft interface 32 is converted (e.g., changed to a format utilized on the bus 54) and/or otherwise conditioned (e.g., filtered, scaled, etc.) for use on the bus 54 of the MCU 30. Similarly, information (e.g., digital and/or serial data) received from the MIL 1760 interfaces 34a-34d, the AIMS interfaces 35 and/or the CART interface 37 also may be conditioned and/or converted for use on the communications bus 54. As noted above, the bus 54, which is controlled by a processor 57, is utilized to transfer the data between the aircraft interface 32 and the MIL interfaces 34a-34d, AIMS interfaces 35 and/or CART interface 37.

Since legacy aircraft 10 generally operate using an analog system or a hybrid analog/digital system, the analog signals originating from the aircraft 10 can be converted to digital signals prior to transmission to the bus 54. Similarly, digital signals received from the weapon 22 can be converted to analog signals prior to providing them to the aircraft interface 32. Thus, the MCU 30, from the point of view of the aircraft's electronics, can appear as an analog system (or an analog/digital hybrid), and the analog aircraft electronics believes it is communicating with an analog system (or an analog/digital hybrid), even though the weapon 22 may be a state of the art digital system.

Operation of the MCU 30 will duplicate the external interface characteristics of the legacy aircraft 10. For example, if the aircraft 10 is not capable of supporting Paveway weapons (e.g., the aircraft's electronics system cannot directly interface with the MIL-STD-1760 interface), the MCU 30 will duplicate the external interface characteristics of the legacy aircraft 10 and translate that data into data that is meaningful to the Paveway weapon (e.g., in MIL-STD-1760 format), and output the data to the correct output of the MIL 1760 interface.

For example, and as shown in FIG. 3, various input signals (e.g., analog, digital, and serial data) are received from the aircraft 10 via the aircraft interface 32. These signals correspond to signals available in the legacy aircraft's electronics and, as will be appreciated, can vary from one aircraft to another. The signals received from the respective input sections are then converted to digital signals. For example, signals provided by the aircraft at analog input 36a can be sensed via analog inputs (e.g., analog to digital converters or ND) and converted to digital, while all outputs provided to the aircraft 10 can be synthesized through analog output (D/A) circuits, both of which may be controlled and monitored by the onboard processor 57.

As will be apparent to those skilled in the art, the signals provided on the discrete inputs 38b and 38c as well as the serial data provided by the bus interface and controller 42 also can be converted for use on the bus 54. Once the signals are converted, the signals may be placed on the bus 54 at the desired time for use as needed (e.g., as requested by the processor 57).

The processor 57, executing application code, then can retrieve the digital data from the aircraft interface 32 as needed, and map the respective data to an output of the MIL 1760 interface 34a-34d, the AIMS interfaces 35 and/or CART interface 37 that corresponds to the same input or same type of input on the weapon 22. In other words, the MCU 30, via the processor 57, memory 58, bus 54 and I/O sections (discrete, analog and serial), translates the legacy data from the legacy aircraft 10 into meaningful data that can be used by the new weapon (e.g., data in the MIL-STD-1760 format or other format). This translated data, for example, then may be output to the weapon 22 via the discrete I/O 46a-46d, 48a-48d, 52 and 53, the SEAM board 55, the CART reroute section 56, and/or via serial communications using the bus interface and controller 42 in conjunction with the bus couplers 50a-50d.

In a similar manner, signals provided by the weapon 22 are received on the MIL 1760 interface 34a-34d, the AIMS interface 35a-35b, and/or the CART interface 37. These signals may be in digital form (e.g., discrete signals or data obtained via the 1553 serial link) or analog form. The signals then may be conditioned (e.g., scaled and/or filtered), and then via the processor 57, mapped to appropriate analog, digital and/or serial I/O sections and converted to the proper signal level before providing the signal to the aircraft interface 32. These signals then can be used by the aircraft 10 to provide status information to the pilot, for example.

Mapping of I/O points from the aircraft interface and each of the MIL 1760 interfaces 34a-34d, the AIMS interfaces 35a-35b and CART interface 37 can be easily changed via application software that can be loaded into the MCU 30. For example, it may be desired to outfit two different legacy aircraft with Paveway weapons, wherein each legacy aircraft may have different electronics (e.g., one may be analog based and the other may be digital, or an analog/digital hybrid, neither of which is equipped to communicate with the MIL 1760 interface of the weapon 22). The MCU 30, via the MIL 1760 interfaces 34a-34d, may directly interface to the Paveway weapon 22. Then, for the first legacy aircraft, the analog I/O 36a and 36b of the aircraft interface 32 may be wired directly to the first legacy aircrafts weapons electronics. Similarly, for the second legacy aircraft, the digital I/O 38a-38c and/or the bus interface and controller 42 may be wired directly to the second legacy aircrafts weapons electronics.

Then, for the first legacy aircraft, application software can be written that maps each analog I/O to a corresponding output of the MIL 1760 interface. The mapping may be to one or more of the MIL 1760 interfaces 34a-34d. Similarly, software can be written that maps each input from the MIL 1760 interface to a corresponding analog output of the aircraft interface 32. This process then can be repeated for the second legacy aircraft. However, instead of mapping the analog I/O points of the aircraft interface 32, the digital and/or serial interfaces of the aircraft interface 32 are used. Once the mapping is complete, the software can be loaded into the MCU 30, where it is stored in memory 58 and executed by the processor 57.

During software execution, the data signals, via the processor 57, are automatically converted to the proper signal level and mapped to the proper input or output. Thus, in the above example two different legacy aircraft 10, neither of which is capable of directly interfacing with a modern weapon 22, now can indirectly interface with the modern weapon 22 without customizing the existing electronics of the legacy aircraft 10 or of the weapon 22.

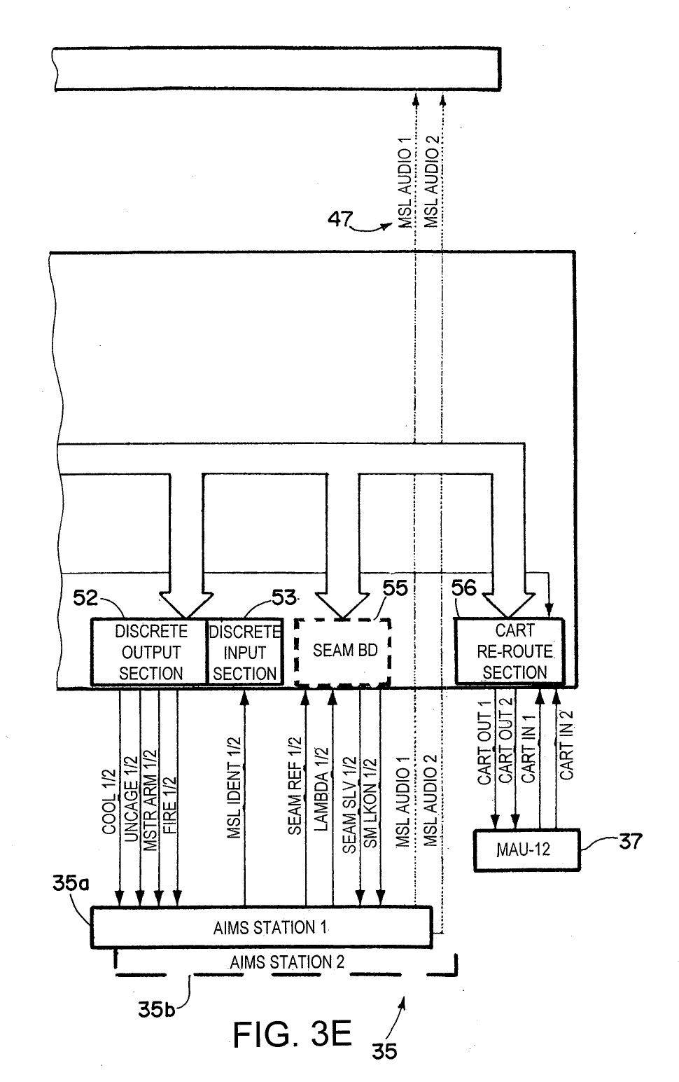

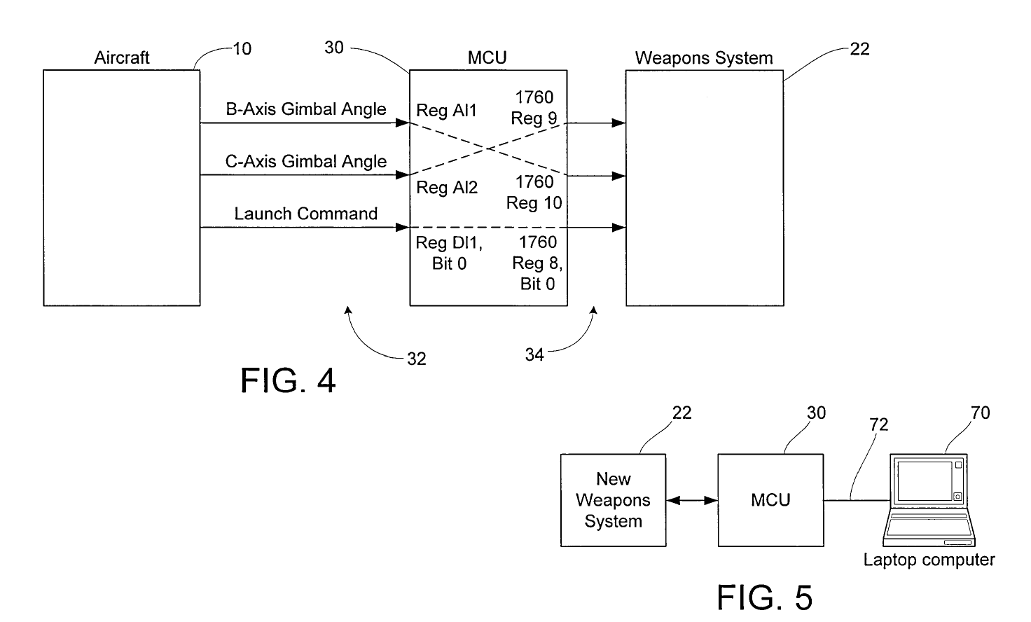

Moving now to FIG. 4, a block diagram is provided showing an exemplary mapping of data from the aircraft interface 32 to the MIL 1760 interface. It is to be appreciated that the mapping is also applicable to the AIMS interfaces 35 and CART interface 37. For sake of brevity, however, exemplary mappings for these interfaces are not shown herein.

In the example of FIG. 4, the aircraft is a legacy aircraft that utilizes analog electronics. Two analog signals (B axis gimbal angle and C axis gimbal angle) are wired from the aircraft's electronics to the MCU 30 via the aircraft interface 32. Since these are analog signals, they are wired to the analog input section 36a of the aircraft interface 32 (e.g., ANALOG INPUT 1 and ANALOG INPUT 2). These inputs (i.e., ANALOG INPUT 1 and ANALOG INPUT 2) may be defined within the MCU 30 as Reg AI1 and Reg AI2. Also wired to the aircraft interface 32 is a launch command signal (e.g., a fire or launch button, signal, or the like). Since this signal is a discrete signal (i.e., on or off), it is wired to the discrete input section (either the active high 38b or the active low 38c inputs). In the present example, it will be assumed that the launch command is wired to the first input of the active high inputs 38b (AH DISC INPUT 1), which may be defined as Reg DI1, Bit 0 in the MCU 30. As will be appreciated, there may be many more I/O points from the aircraft electronics wired to the MCU 30 (and vice-versa). Further, these inputs (and outputs) may be wired to different I/O points of the aircraft interface 32 than described above (e.g., B-axis gimbal may be wired to analog input 3 instead of analog input 1). However, for sake of brevity, only these three inputs will be discussed using the exemplary connection scheme.

Also wired to the MCU 30 is the weapon 22. In the present example, the weapon operates using the MIL 1760 standard, which includes a serial communications interface (e.g., based on MIL-STD-1553). Thus, analog signals such as the B-axis and C-axis gimbal angle received from the aircraft's electronics may be serially communicated to the weapon 22 via the MIL-STD-1553 serial bus (e.g., using the bus interface and controller 42 of the MCU 30 and the bus couplers 50a-50d). As will be appreciated, there may be predefined registers for the B-axis and C-axis gimbal angles in the weapon. For example, register 10 of the weapon 22 may be dedicated to the B-axis gimbal angle, while register 9 of the weapon 22 may be dedicated to the C-axis gimbal angle.

The launch command also may be serially communicated to the weapon 22, or it may be a hardwired digital I/O point to the weapon 22. In the present example, it will be assumed that the launch command is serially transmitted to the weapon, and that Register 8, bit 0 of the weapon 22 corresponds to a weapons launch.

Once the I/O for the respective systems have been defined and wired, then application software may be written that maps the aircraft I/O points to the weapon I/O points. In addition to mapping the I/O points, the software also may condition the data (e.g., filter, scale, etc.) so as to provide enhanced performance of the system. For example, in mapping the B-axis gimbal angle, Reg AI1 (the analog input register of the MCU corresponding to ANALOG INPUT 1) is associated with Reg 10 of the weapon (the analog input register of the weapon corresponding to the B-axis gimbal angle). Similarly, the C-axis gimbal angle Reg AI2 (the analog input register of the MCU corresponding to ANALOG INPUT 2) is associated with Reg 9 of the weapon 22 (the register of the weapon associated with the C-axis gimbal angle), and the launch command Reg DI1, B0 (the digital input of the MCU corresponding to AH DISC INPUT 1) is associated with Reg 8, bit 0 of the weapon (the digital input of the weapon associated with a launch command). Such associations may be stored in a look up table or via other conventional means and stored in memory 58 of the MCU 30, for example.

As the processor 57 executes the code stored in memory 58, it may read the value at Reg AI1, and then read the mapped destination register for Reg AI1 (which in this example is Reg. 10). The processor 57 then writes the value read from Reg AI1 into Reg 10. Further, the processor 57 may apply filtering (e.g., low pass, high pass, notch, etc.) and/or scale the data, if needed, prior to writing the data.

For example, if a 0-5V signal input at ANALOG INPUT 1 of FIG. 3 is represented as 0-4095 counts within the MCU 30, and if the weapon 22 expects the gimbal angle to be in degrees*100, then the processor 57, prior to writing the data to Reg 10, scales the data such that 0 counts is 0 (i.e., 0 degrees), and 4095 counts is 36000 (i.e., 360 degrees*100). Similar filtering and/or scaling may be applied to Reg AI2 (e.g., the value in Reg AI2 is filtered and/or scaled, and then written to Reg 9).

A similar approach may be applied to the discrete data, but instead of writing a single discrete data point to an entire register, the discrete data may be packed within a register (e.g., each discrete data point is defined by the register number and the bit within the register). In this manner, multiple discrete data may be transferred in a single register (e.g., for a 16-bit register, 16 different discrete data points can be packed into a single register).

Referring now to FIG. 5, the MCU 30 may be under the control of an external or otherwise separate computer 70, such as a personal computer or the like. For example, a lap top computer 70 or the like may be communicatively coupled to the MCU 30 via the communication port 60 (e.g., a serial cable 72 or the like coupled between the computer 70 and the port 60 of the MCU 30).

The computer 70, which may be a Microsoft Windows™ based computer, may execute application specific code for interfacing with the MCU 30. The application specific code may generate one or more graphical user interfaces that simplify operation and/or configuration of the respective weapons interfaces (e.g., the MIL 1760 interfaces 34, the AIMS interfaces 35 and/or the CART interface 37).

Using the computer 70, data, such as commands, status information, etc., may be sent to the MCU 30. Further, the computer may receive status information from the MCU (e.g., acknowledgement of commands, status of weapon, etc.). In this manner, a user may directly control the MCU 30 from the computer 70. That is, commands to arm, acquire a target, launch, etc. may be issued directly from the computer 70, independent of the aircraft's electronics. In certain applications (e.g., on certain helicopter platforms or large maritime patrol aircraft in which a computer, such as a lap top computer, may be used), the MCU 30 need not be coupled to the aircraft electronics, and may be solely controlled from the computer 70.

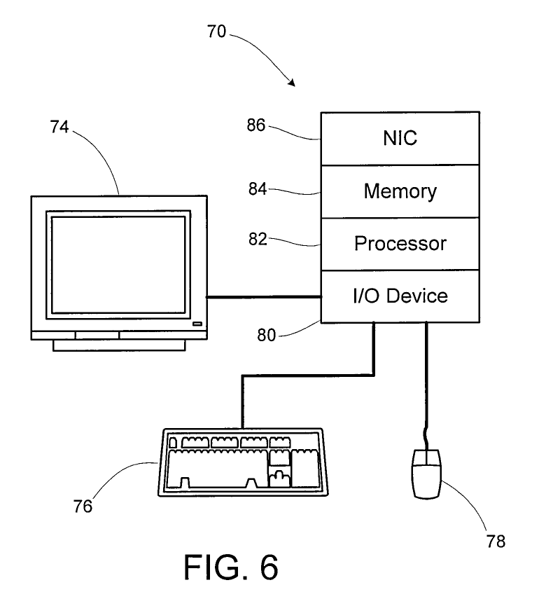

FIG. 6 is a block diagram of an exemplary computer 70 that may be used with the MCU 30. The computer 70 may include a display 74 for viewing system information, and a keyboard 76 and pointing device 78 for data entry, screen navigation, etc. A computer mouse or other device that points to or otherwise identifies a location, action, etc., e.g., by a point and click method or some other method, are examples of a pointing device 78. Alternatively, a touch screen (not shown) may be used in place of the keyboard 76 and pointing device 78. The display 74, keyboard 76 and mouse 78 communicate with a processor via an input/output device 80, such as a video card and/or serial port (e.g., a USB port or the like).

A processor 82, such as an AMD Athlon 64® processor or an Intel Pentium IV® processor, combined with a memory 84 execute programs to perform various functions, such as data entry, numerical calculations, screen display, system setup, etc. The memory 84 may comprise several devices, including volatile and non-volatile memory components. Accordingly, the memory 84 may include, for example, random access memory (RAM), read-only memory (ROM), hard disks, floppy disks, optical disks (e.g., CDs and DVDs), tapes, flash devices and/or other memory components, plus associated drives, players and/or readers for the memory devices. The processor 82 and the memory 84 are coupled together via a local interface (not shown). The local interface may be, for example, a data bus with accompanying control bus, a network, or other subsystem.

The memory may form part of a storage medium for storing information, such as application data, screen information, programs, etc., part of which may be in the form of a database. The storage medium may be a hard drive, for example, or any other storage means that can retain data, including other magnetic and/or optical storage devices. A network interface card (NIC) 86 allows the computer 70 to communicate with other devices.

A person having ordinary skill in the art of computer programming and applications of programming for computer systems would be able in view of the description provided herein to program the MCU 30 and/or computer 70 to operate and to carry out the functions described herein. Accordingly, details as to the specific programming code have been omitted for the sake of brevity. Also, while software in the memory 58 and/or 84 or in some other memory of the MCU 30 and/or computer 70 may be used to allow the system to carry out the functions and features described herein in accordance with the preferred embodiment of the invention, such functions and features also could be carried out via dedicated hardware, firmware, software, or combinations thereof, without departing from the scope of the invention.

Accordingly, a munitions control unit has been described that enables legacy vehicles, such as legacy aircraft, to be upgraded with the latest weapons without modification to the vehicle's electronics or to the weapon's electronics. Moreover, the munitions control unit can incorporate a fixed hardware design, and yet be operable to accommodate a variety of platform interface requirements.

Although the invention has been shown and described with respect to a certain preferred embodiment or embodiments, it is obvious that equivalent alterations and modifications will occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the invention. In addition, while a particular feature of the invention may have been described above with respect to only one or more of several illustrated embodiments, such feature may be combined with one or more other features of the other embodiments, as may be desired and advantageous for any given or particular application.

1. A munitions control unit for integrating existing vehicle electronics with at least one weapon, wherein said existing vehicle electronics are not equipped to interface with the at least one weapon, comprising:
a first I/O interface operative to communicate control signals with said vehicle;
at least one second I/O interface different from the first I/O interface, said at least one second I/O interface operative to communicate control signals with said weapon;
a processor and memory operatively coupled to said first and at least one second I/O interface;
programmable mapping logic stored in memory and executable by the processor, said programmable mapping logic defining an I/O map for exchanging communication signals between the first and at least one second I/O interface; and
a programming port operatively coupled to the processor and memory for receiving the programmable mapping logic.

2. The munitions control unit of claim 1, wherein the programmable mapping logic includes logic that communicates control signals received at the first I/O interface to the at least one second I/O interface for use by the weapon.

3. The munitions control unit of claim 2, wherein the programmable mapping logic includes logic that communicates control signals received at the at least one second I/O interface to the first I/O interface for use by the vehicle.

4. The munitions control unit according to claim 3, wherein the programmable mapping logic includes logic that scales at least some of the control signals prior to communicating said control signals between the first and at least one second I/O interface.

5. The munitions control unit according to claim 3, wherein the programmable mapping logic includes logic that filters at least some of the control signals prior to communicating said control signals between the first and at least one second I/O interface.

6. (canceled)

7. The munitions control unit of claim 1, wherein the at least one second interface is an MIL-STD-1760 compliant interface.

8. The munitions control unit according to claim 7, wherein the at least one second interface includes a plurality of discrete I/O points and an MIL-STD-1553 compliant interface.

9. The munitions control unit of claim 7, wherein the first I/O interface comprises a plurality of analog I/O points and a plurality of discrete I/O points.

10. (canceled)

11. The munitions control unit of claim 9, further comprising a power supply interface operative to receive power from the vehicle to power the munitions control unit.

12. The munitions control unit of claim 11, further comprising at least one video switch operative to communicate video signals between the first and at least one second I/O interface.

13. The munitions control unit of claim 7, wherein the first I/O interface further includes an MIL-STD-1553 complaint interface.

14. The munitions control unit of claim 1, wherein the vehicle is a tank or an aircraft.

15. (canceled)

16. The munitions control unit of claim 1, wherein the at least one second interface is an air-to-air weapon interface or an air-to-ground weapon interface.

17. The munitions control unit of claim 1, wherein the at least one second interface is a plurality of interfaces, and each interface of the plurality of interfaces is selectively operable to be enabled or disabled based on information corresponding to the at least one weapon.

18. The munitions control unit of claim 1, wherein the processor is operative to accept control commands from an external processor not part of the munitions control unit.

19. A method for integrating existing vehicle electronics with at least one weapon, wherein said existing vehicle electronics are not equipped to interface with the at least one weapon, comprising:
communicatively coupling a first I/O interface of a munitions control unit to the vehicle;
communicatively coupling at least one second I/O interface of the munitions control unit to the weapon, said at least one second I/O interface being different from the first I/O interface; and
communicatively coupling at least one I/O point of the first I/O interface to at least one I/O point of the at least one second I/O interface, wherein communicatively coupling the respective I/O points includes storing programmable mapping logic onto the munitions control unit, said programmable mapping logic defining a communication path between the at least one I/O point of the first I/O interface and the at least one I/O point of the at least one second I/O interface.

20. The method of claim 19, wherein communicatively coupling includes using two-way communications between the first I/O interface and the at least one second I/O interface.

21. The method of claim 19, wherein communicatively coupling includes scaling a signal communicated between the at least one I/O point of the first I/O interface and the at least one I/O point of the at least one second I/O interface.

22. The method of claim 19, wherein communicatively coupling includes filtering a signal communicated between the at least one I/O point of the first I/O interface and the at least one I/O point of the at least one second I/O interface.

23. The method of claim 19, further comprising controlling the programmable mapping logic from a computing device remote from the munitions control unit.

24. A munitions control for integrating existing vehicle electronics with at least one weapon, wherein said existing vehicle electronics is not equipped to interface with the at least one weapon, comprising:
a first I/O section operative to communicate I/O data with the vehicle;
a second I/O section operative to communicate I/O data with the at least one weapon; and
a reconfigurable processing section including programmable mapping logic for correlating I/O points of the first I/O section with corresponding I/O points of the second I/O section.

25. A munitions control unit for integrating existing aircraft electronics of an aircraft and software with a store internally wired with an MIL-STD-1553 data bus for coupling to an MIL-STD-1760 interface, wherein said existing aircraft electronics and software include analog and discrete I/O, and a video input that are not equipped to interface with the store's MIL-STD-1760 interface, said munitions control unit comprising:
an aircraft interface including pluralities of analog I/O and discrete I/O operative to communicate control and/or status signals with said existing aircraft electronics, and a video output;
a MIL-STD-1760-compliant interface including discrete I/O and a MIL-STD-1553 data bus operative to communicate control signals and data with said store;
an internal bus that operatively couples said aircraft interface and said discrete I/O of the MIL-STD-1760 interface;
a MIL-STD-1553 bus controller operatively coupled between said bus and said MIL-STD-1553 data bus to enable indirect communication between the existing aircraft electronics and store over the MIL-STD-1553 data bus;
a graphics generator operatively coupled between the bus and the aircraft interface video output that renders graphical images to the aircraft video input for display in the aircraft;
a processor and memory operatively coupled to said bus; and
programmable mapping logic stored in memory and executable by the processor, said programmable mapping logic defining an I/O map for communicating control signals and data between the aircraft and the MIL-STD-1760 interfaces; and
a programming port operatively coupled to the processor and memory for receiving the programmable mapping logic.

26. The munitions control unit of claim 25, wherein the unit accepts inputs from and provides outputs to the existing aircraft electronics in its native format and provides outputs and accepts inputs from the store in its native format without modification to the existing aircraft electronics or software or the store's electronics and software.

27. The munitions control unit of claim 25, wherein the aircraft interface's analog I/O and discrete I/O may be coupled to any analog I/O or discrete I/O point of the existing aircraft electronics based upon the electronics and software present in the aircraft.

28. The munitions control unit of claim 25, wherein the processor manipulates data from the existing aircraft electronics and the store to control the graphical images rendered by the graphics generator.

29. The munitions control unit of claim 25, wherein the analog and discrete data received from the aircraft interface and the discrete and serial data received from the MIL-STD-1760-compliant interface are at least one of converted or conditioned to a format utilized by the internal bus.

30. The munitions control unit of claim 29, wherein analog data from the aircraft interface are converted to digital signals for transfer on the internal bus, said MIL-STD-1553 bus controller interpreting the digital signals as required and providing them as serial digital data to the MIL-STD-1553 data bus, and wherein serial digital data from the MIL-STD-1553 data bus is converted to digital signals for transfer on the internal bus and converted to analog signals provided to the analog I/O of the aircraft interface.

31. The munitions control unit of claim 1, further comprising a graphics generator operatively coupled to the processor and the first I/O interface, wherein the graphics generator is operative to render graphical images for display in the vehicle.

32. The munitions control unit according to claim 1, further comprising a CART interface operative to release the weapon from the vehicle.
